(19) United States
(12) Patent Application Publication
(10) Pub. No.: US 2002/0090069 A1
(43) Pub. Date: Jul. 11, 2002

(54) Automatic processing of incoming email and voice mail messages

(76) Inventor: Rhoda Yaker, Annandale, NJ (US)

Correspondence Address: MENDELSOHN AND ASSOCIATES PC, 1515 MARKET STREET, SUITE 715, PHILADELPHIA, PA, 19102, US

(21) Appl. No.: 09/756,155

(22) Filed: Jan. 8, 2001

(51) Int. Cl. H04M 1/64

(52) U.S. Cl. 379/88.17

(57) ABSTRACT

A computer system coordinates the receipt of incoming messages, such as electronic mail (email) and/or voice mail messages, from third parties with a user's computer-based personal scheduler to automatically forward outgoing messages to the third parties based upon the unavailability of the user. In one embodiment, for email messages, upon the receipt of an incoming email message from a third party, the user's computer-based email application accesses information previously stored in the user's computer-based personal scheduler to determine the current availability of the user and automatically sends an appropriate outgoing email message to the third party when the user is unavailable. The amount and type of information contained within the outgoing email message may depend on the type of current activity stored in the user's personal scheduler and/or the source of the incoming message. The present invention can also be implemented in the context of processing incoming telephone calls, where a voice mail system automatically accesses information from the callee's personal scheduler to determine the availability of the callee and select an appropriate outgoing greeting message to be played to the caller. In alternative embodiments, the personal scheduler configures the user's electronic and/or voice mail systems based on information stored in the personal scheduler, prior to the receipt of an incoming message or call.

### BACKGROUND OF THE INVENTION

1. Field of the Invention

The present invention relates to computer-based applications providing voice mail and/or electronic mail capabilities.

2. Description of the Related Art

Some computer-based electronic mail (email) applications provide users with the ability to configure their computers to automatically transmit reply messages upon receipt of incoming email messages from third parties. This feature is typically used to notify the third parties that the recipient of the email message is out of the office for an extended period of time, for example, for vacation.

In some of these email applications, the user must manually compose the “out-of-office” message, manually turn on the automatic reply feature when the user is leaving the office to activate the function, and then manually turn off the feature when the user returns to the office to deactivate the function. Other email applications enable the user to manually enter start and end dates that will then be used by the system to automatically activate and then automatically deactivate the automatic reply function based on the manually entered start and end dates.

Similarly, voice mail systems enable users to configure their telephone systems to play a prerecorded outgoing voice message whenever the voice mail system answers an incoming call. Some voice mail systems enable users to record a special “out-of-office” greeting for use when the user will be away from the office for an extended period of time. In addition to manually recording the special out-of-office message, the user must manually configure the voice mail system when the user leaves the office to turn on the special “out-of-office” message, and then manually configure the voice mail system when the user returns to the office to turn off the special “out-of-office” message and resume using his or her normal greeting message.

Independent of these various email and voice mail functions, computer-based personal scheduling applications exist to provide users with the ability to enter their individual schedules into their computer systems. These personal schedulers allow users to manually enter the start and end times and dates for their various activities.

### SUMMARY OF THE INVENTION

The present invention is directed to computer-based processing that allows an email system and/or a voice mail system to access information from a user's personal scheduler in order to automatically activate and deactivate the “out-of-office” messaging functions in those systems. Based on that information, the email or voice mail system automatically determines what type of messages, if any, to transmit to third parties in response to incoming email messages or telephone calls. In alternative embodiments, the personal scheduler appropriately configures the user's electronic and/or voice mail systems based on information stored in the personal scheduler, prior to the receipt of an incoming message or call. The present invention eliminates the requirement for the user to have to manually configure his or her email and/or voice mail systems to activate and deactivate the “out-of-office” messaging functions provided by those systems.

In one embodiment, the present invention is a computer-based method for processing incoming messages from third parties, comprising the steps of (a) receiving an incoming message from a third party intended for a user; and (b) supplying an outgoing message in response to the incoming message, wherein the outgoing message is selected as a function of information stored in a computer-based personal scheduler.

In another embodiment, the present invention is a computer-based system for processing incoming messages from third parties, comprising (a) a message processor configured to process incoming messages from third parties intended for a user; and (b) an interface configured to provide access by the message processor to information logged into a computer-based personal scheduler, wherein the message processor is configured to (1) receive an incoming message from a third party intended for the user; and (2) supply an outgoing message in response to the incoming message, wherein the outgoing message is selected as a function of information stored in a computer-based personal scheduler.

In yet another embodiment, the present invention is a computer-based system for processing incoming messages from third parties, comprising (a) a message processor and (b) a personal scheduler. The personal scheduler is coupled to the message processor so that an incoming message is processed as a function of information stored in the personal scheduler.

### BRIEF DESCRIPTION OF THE DRAWINGS

Other aspects, features, and advantages of the present invention will become more fully apparent from the following detailed description, the appended claims, and the accompanying drawings in which:

FIG. 1 shows a block diagram of an email tool and personal scheduler, according to one embodiment of the present invention;

FIG. 2 shows a flow diagram of the processing implemented by the system of FIG. 1 related to the synchronization between the email tool and the personal scheduler;

FIG. 3 shows a block diagram of a telecommunications device and a personal scheduler, according to a second embodiment of the present invention;

FIG. 4 shows a flow diagram of the processing implemented by the system of FIG. 3 related to the synchronization between the telecommunication device and the personal scheduler; and

FIG. 5 shows a flow diagram of the processing implemented by the system of FIG. 1, according to an alternative embodiment of the present invention.

### DETAILED DESCRIPTION

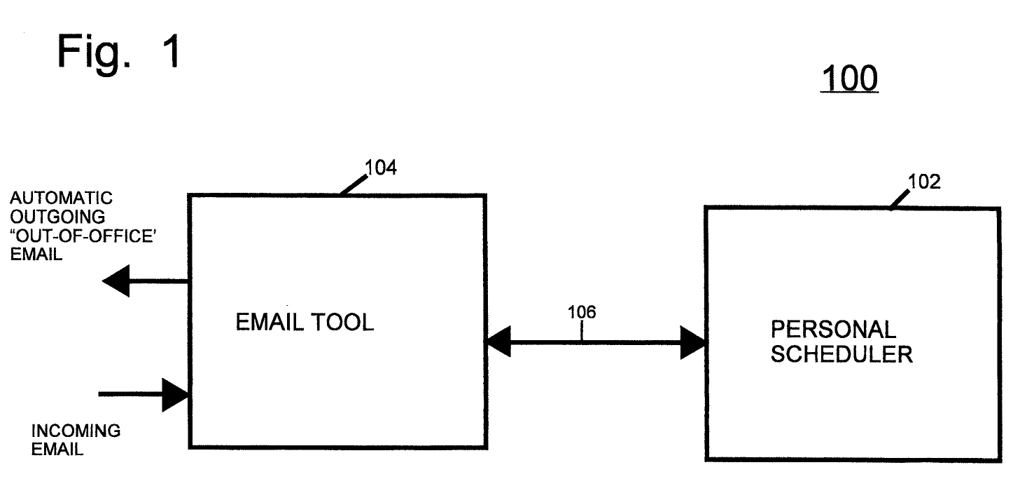

FIG. 1 shows a block diagram of a computer system 100 including a software-based personal scheduler 102 and a software-based email tool 104, according to one embodiment of the present invention. Computer system 100 can be any suitable type of computer such as a desktop personal computer or a workstation.

Personal scheduler 102 is a part of computer system 100 and is used to store information representing the user's daily appointments and information concerning actions to be performed by the user. As used herein, a personal scheduler is a general term for an electronic calendar, stored appointment book, or any other conventional computer software that stores electronically one's daily activities or “out-of-office” events. Personal scheduler 102 may be any suitable computer software designed for managing daily appointments and which will make the information stored within the system accessible to an email application, such as email tool 104.

In operation, the user inputs his/her daily appointments for storage in personal scheduler 102. An appointment may be entered into the system and assigned a category as to the type of appointment including, for example, “meeting,” “out of office,” “business trip,” “vacation,” “lunch,” etc. Each of these appointments may also have additional information input such as time and length of meeting, dates or length of time that the user will be away on the business trip or vacation, and possibly other attendees at a particular meeting.

Email tool 104, also a part of computer system 100, manages the receipt of incoming email messages and transmission of outgoing email messages. Email tool 104 can be affiliated with any suitable type of computer network, such as a local area network or intranet or a wide area network or internet.

In the present invention, email tool 104 accesses, via software interface 106, personal computer 100 and based on information stored in personal scheduler 102 concerning the user's unavailability to respond to an incoming email message, email tool 104 will automatically transmit a previously prepared email message to the third party that sent the incoming email message.

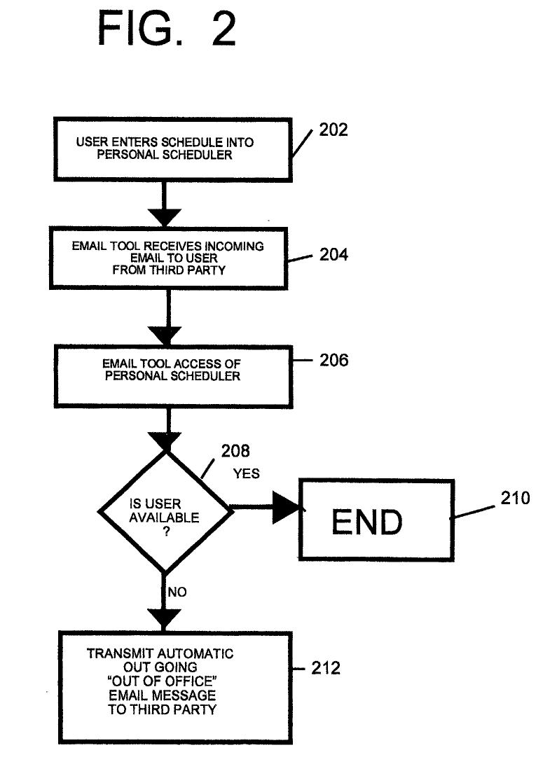

FIG. 2 shows a flow diagram of the processing implemented by computer system 100 of FIG. 1, according to one embodiment of the present invention. The user enters his or her schedule into the personal scheduler (step 202 of FIG. 2). The information entered includes the timing of a scheduled activity. The timing may be specified by a start date, start time, and duration, or by a start date, start time, end date, and end time. In addition, the personal scheduler may provide categories for the information to be stored. Such categories may include, for example, “meeting,” “business trip,” “lunch,” “vacation,” and “out-of-office.”

When the email tool receives an incoming email message from a third party (step 204), the email tool accesses the personal scheduler (step 206) via interface 106. An evaluation is then made to determine whether the user is available to receive the message at that time (step 208). If the user does not have a suitable entry in the personal scheduler and is therefore presumably available to receive and respond to incoming email messages, processing ends (step 210).

If, however, an entry had been made in the personal scheduler indicating that the user is not available, then the email tool automatically transmits an appropriate “out-of-office” email message to the third party (step 212). The outgoing “out-of-office” message may include information concerning the user's whereabouts (i.e., the categories enumerated above, such as, for example, in a meeting, out of town on business, on vacation, and the like), as well as the duration of time the user will be out of the office or the date upon which the user will be back in the office.

In addition, the user may prepare a series of messages providing different information wherein the email tool is programmed to disseminate a particular message depending on particular circumstances. For example, different messages may be sent depending on the type of activity entered into the personal scheduler, where the different messages provide the third party with different information depending on the type of activity. Alternatively or in addition, the email tool may interpret the incoming email message based on pre-determined criteria, such as but not limited to, the source of the email message (i.e., whether it be within the network or outside the user's network) or key words found within the email message that serve to trigger a certain prepared response. Finally, the incoming message from the third party and the outgoing message from the user are logged in the in box and out box, respectively, of the email system of the user.

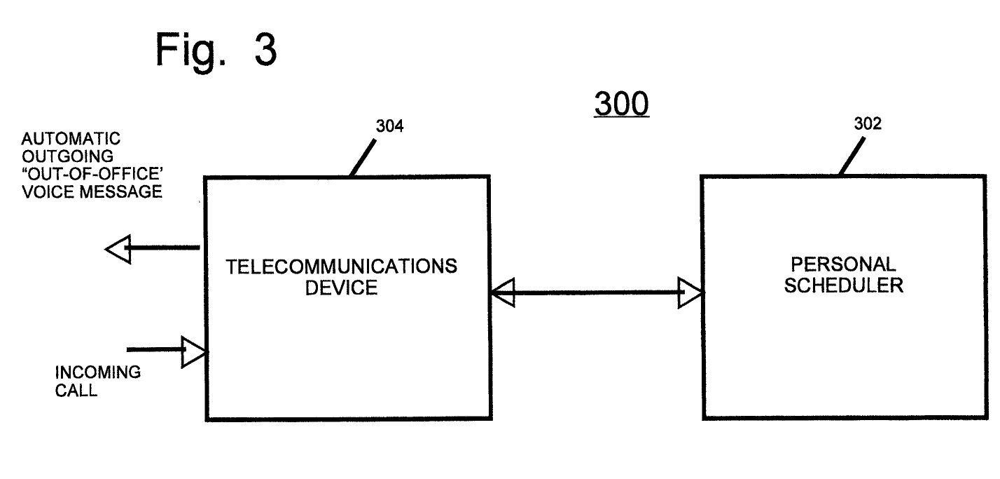

FIG. 3 shows a block diagram of a computer system 300, according to a second embodiment of the present invention, in which the computer system has a personal scheduler 302 and a telecommunications device 304. As in computer system 100 of FIG. 1, in this embodiment, personal scheduler 302 is a part of computer system 300 and is used to store information representing daily appointments and information concerning actions to be performed. Personal scheduler 302 is similar to the personal scheduler described above with respect to the first embodiment.

Telecommunications device 304 may include but not be limited to a conventional telephone, portable telephone, cellular telephone, and other devices. Telecommunications device 304 manages the receipt of incoming calls. In this embodiment, the user may prepare for transmission a personal message concerning his/her unavailability as being “out-of-office” similar to the conventional preparation as made with existing voice mail or telephone exchange systems. Alternatively, a preprogrammed digital message may be transmitted. As shown in FIG. 3, the incoming call is received by telecommunications device 304, which then accesses personal scheduler 302 via software interface 306 to determine whether the user is available to receive the call.

Alternatively, but not shown, the incoming call may be received by telecommunications device 304 and the content of the incoming message subsequently processed into computer-coded information with the use of existing technology, such as voice-to-text and/or voice recognition processors, and stored in a computer message center. Similar to above, the computer-coded information is then synchronized with the user's personal scheduler 302 so that a determination is made as to the availability of the user. If the user is unavailable, an automatic outgoing “out-of-office” voice message is relayed to the third party sender. In addition, the computer-coded information of the incoming message may be forwarded to the user's email incoming box and further processed in accordance with the protocol described above with respect to FIGS. 1 and 2.

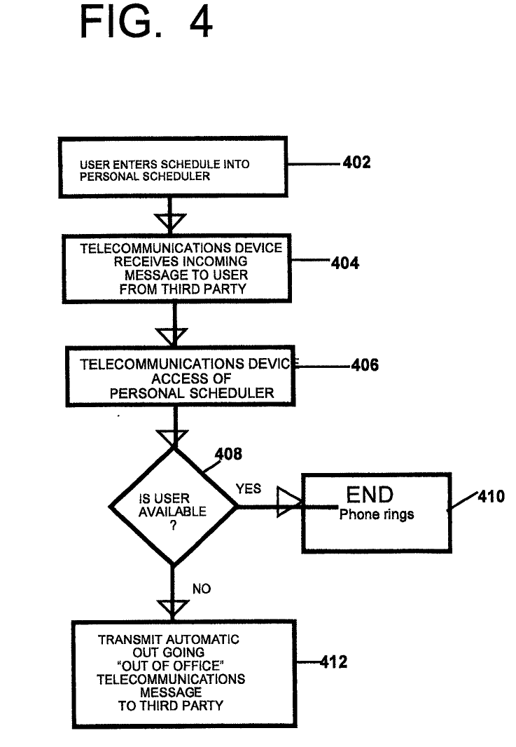

FIG. 4 shows a flow diagram of the processing steps implemented by computer system 300 of FIG. 3, according to one embodiment of the present invention. In particular, the user enters his or her schedule of appointments and activities and dates into the personal scheduler (step 402 of FIG. 4). When the telecommunications device subsequently receives an incoming call from a third party (step 404), the telecommunications device accesses the user's personal scheduler (step 406) and determines the availability of the user (step 408). If the user is available, then the call is handled in a conventional manner (step 410). In particular, the phone rings and, if the user does not answer within a specified number of rings, then the voice mail system answers the call, plays the user's standard outgoing greeting message to the caller, and records a voice mail message for the user to listen to later.

If, however, the user is not available, then an appropriate prerecorded “out-of-office” voice message is automatically played to the third party caller (step 412). As described above with respect to the email protocol, additional information may also be relayed to the third party concerning the user's whereabouts (e.g., vacation, lunch, business trip), the length of time the user is unavailable or when the user will be back in the office. The caller is then able to record a voice message for later access by the user.

As in the previous embodiment, the user may prerecord different types of “out-of-office” voice messages and the computer system will automatically select an appropriate message depending on, for example, the type of activity logged in the personal scheduler and/or the identity of the third party caller.

For both embodiments, as an alternative to out-of-office voice messages prerecorded by the user, the outgoing voice messages may be at least partially computer-generated, for example, based on information stored in the personal scheduler. Such a technique may be implemented using conventional text-to-voice converters for the computer-generated portions of the outgoing messages.

Additional processing steps, not shown in the figures may include the further processing of the content of the incoming message from the telecommunications device into computer-coded language with the use of existing technology and the subsequent transfer of the computer-coded information to the user's email system for further action.

In the previously described embodiments of the present invention, the email tool or telecommunications device accesses information from the personal scheduler after receipt of an incoming email message or telephone call to determine the availability of the user. In alternative embodiments of the present invention, the personal scheduler configures the email tool and/or telecommunications device based on information stored in the personal scheduler, prior to the receipt of an incoming message or call.

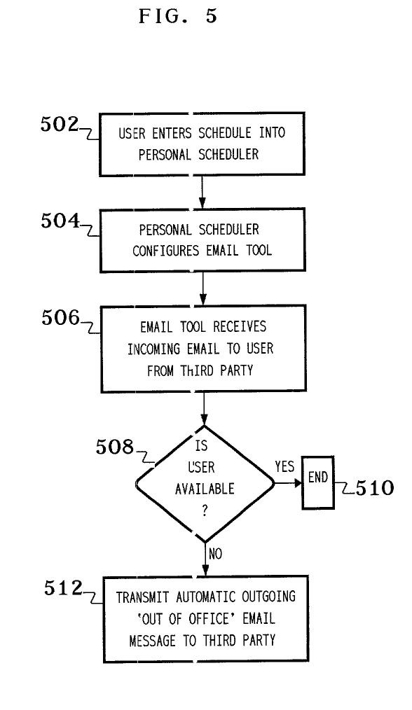

FIG. 5 shows a flow diagram of the processing implemented by computer system 100 of FIG. 1, according to one of these alternative embodiments of the present invention. According to this embodiment, the user enters his or her schedule into personal scheduler 102 (step 502 of FIG. 5). Personal scheduler 102 configures email tool 104 via interface 106 based on the information entered by the user (step 504). For example, if the information stored in the personal scheduler indicates that the user will be on vacation from 5 pm on Jul. 1 until 9 am on Jul. 6, then, at about 5 pm on Jul. 1, the personal scheduler automatically configures the user's email tool for special out-of-office processing. Similarly, at about 9 am on Jul. 6, the personal scheduler automatically reconfigures the user's email tool for normal processing.

When the email tool receives an incoming email message from a third party (step 506), the email tool determines whether the user is available to receive the message at that time based on its current configuration (step 508). If the email tool is configured for normal processing indicating that the user is available, then processing ends (step 510). If, however, the email tool is configured for special out-of-office processing, then the email tool automatically transmits an appropriate “out-of-office” email message to the third party (step 512).

Of course, those skilled in the art will understand that alternative embodiments of the present invention analogous to that of FIG. 5 may be implemented for voice mail systems in the context of computer system 300.

The exemplary embodiments of the present invention have been described with respect to personal schedulers and calendars as well as electronic mail and voice mail systems. These functions may be implemented in hardware-based solutions or as processing steps in appropriate software programs. Such software may be employed in, for example, a digital signal processor, micro-controller, or general-purpose computer. Moreover, in addition to personal computer (PC)-based solutions, the present invention can also be implemented in the context of laptop and other portable computers, personal data assistants (PDAs), cellular phones, and other similar devices that can provide both personal scheduling and electronic and/or voice mail capabilities.

The present invention can be embodied in the form of methods and apparatuses for practicing those methods. The present invention can also be embodied in the form of program code embodied in tangible media, such as floppy diskettes, CD-ROMs, hard drives, or any other machine-readable storage medium, wherein, when the program code is loaded into and executed by a machine, such as a computer, the machine becomes an apparatus for practicing the invention. The present invention can also be embodied in the form of program code, for example, whether stored in a storage medium, loaded into and/or executed by a machine, or transmitted over some transmission medium or carrier, such as over electrical wiring or cabling, through fiber optics, or via electromagnetic radiation, wherein, when the program code is loaded into and executed by a machine, such as a computer, the machine becomes an apparatus for practicing the invention. When implemented on a general-purpose processor, the program code segments combine with the processor to provide a unique device that operates analogously to specific logic circuits.

It will be further understood that various changes in the details, materials, and arrangements of the parts which have been described and illustrated in order to explain the nature of this invention may be made by those skilled in the art without departing from the scope of the invention as expressed in the following claims.

What is claimed is:

1. A computer-based method for processing incoming messages from third parties, comprising the steps of:
(a) receiving an incoming message from a third party intended for a user; and
(b) supplying an outgoing message in response to the incoming message, wherein the outgoing message is selected as a function of information stored in a computer-based personal scheduler.

2. The invention of claim 1, wherein the supplying step comprises the steps of:
(1) automatically accessing information from the personal scheduler in response to receipt of the incoming message to determine current availability of the user; and
(2) automatically transmitting the outgoing message to the third party based on the information accessed from the personal scheduler.

3. The invention of claim 1, wherein:
the incoming message is an incoming email message received at a computer-based email system; and
the outgoing message is an outgoing email message transmitted to the third party.

4. The invention of claim 3, wherein the personal scheduler configures the computer-based email system to select the outgoing email message based on information stored in the personal scheduler prior to the receipt of the incoming email message.

5. The invention of claim 1, wherein:
the incoming message is an incoming telephone call received at a voice mail system; and
the outgoing message is an outgoing voice message transmitted to the third party.

6. The invention of claim 5, wherein the personal scheduler configures the voice mail system to select the outgoing voice message based on information stored in the personal scheduler prior to the receipt of the incoming telephone call.

7. The invention of claim 1, wherein information in the outgoing message is selected based on a particular type of current activity for the user logged into the personal scheduler, wherein different information is associated with different types of user activities capable of being logged into the personal scheduler.

8. The invention of claim 1, wherein information in the outgoing message is selected based on information regarding the third party.

9. The invention of claim 1, wherein the receiving step comprises the step of the user logging the information into the personal scheduler prior to the receipt of the incoming message from the third party.

10. The invention of claim 1, wherein the receiving step comprises the step of the user composing the outgoing message prior to the receipt of the incoming message from the third party.

11. The invention of claim 1, wherein:
the receiving step comprises the steps of
(1) the user logging the information into the personal scheduler prior to the receipt of the incoming message from the third party; and
(2) the user composing the outgoing message prior to the receipt of the incoming message from the third party;
when the incoming message is an incoming email message received at a computer-based email system, then the outgoing message is an outgoing email message transmitted to the third party;
when the incoming message is an incoming telephone call received at a voice mail system, then the outgoing message is an outgoing voice message transmitted to the third party; and
information in the outgoing message is selected based on at least one of (1) a particular type of current activity for the user logged into the personal scheduler, wherein different information is associated with different types of user activities capable of being logged into the personal scheduler and (2) information regarding the third party.

12. A computer-based system for processing incoming messages from third parties, comprising:
(a) means for receiving an incoming message from a third party intended for a user; and
(b) means for supplying an outgoing message in response to the incoming message, wherein the outgoing message is selected as a function of information stored in a computer-based personal scheduler.

13. A computer-based system for processing incoming messages from third parties, comprising:
(a) a message processor configured to process incoming messages from third parties intended for a user; and
(b) an interface configured to provide access by the message processor to information logged into a computer-based personal scheduler, wherein the message processor is configured to:
(1) receive an incoming message from a third party intended for a user; and
(2) supply an outgoing message in response to the incoming message, wherein the outgoing message is selected as a function of information stored in a computer-based personal scheduler.

14. The invention of claim 13, wherein:
the message processor automatically accesses information from the personal scheduler in response to receipt of the incoming message to determine current availability of the user; and
the message processor automatically transmits the outgoing message to the third party based on the information accessed from the personal scheduler.

15. The invention of claim 13, wherein:
the message processor is a computer-based email system;
the incoming message is an incoming email message received at the computer-based email system; and
the outgoing message is an outgoing email message transmitted to the third party.

16. The invention of claim 15, wherein the personal scheduler configures the computer-based email system to select the outgoing email message based on information stored in the personal scheduler prior to the receipt of the incoming email message.

17. The invention of claim 13, wherein:
the message processor is a voice mail system;
the incoming message is an incoming telephone call received at the voice mail system; and
the outgoing message is an outgoing voice message transmitted to the third party.

18. The invention of claim 17, wherein the personal scheduler configures the voice mail system to select the outgoing voice message based on information stored in the personal scheduler prior to the receipt of the incoming telephone call.

19. The invention of claim 13, wherein information in the outgoing message is selected based on a particular type of current activity for the user logged into the personal scheduler, wherein different information is associated with different types of user activities capable of being logged into the personal scheduler.

20. The invention of claim 13, wherein information in the outgoing message is selected based on information regarding the third party.

21. The invention of claim 13, wherein the information has been logged by the user into the personal scheduler prior to the receipt of the incoming message from the third party.

22. The invention of claim 13, wherein the outgoing message has been composed by the user prior to the receipt of the incoming message from the third party.

23. The invention of claim 13, wherein:
the information has been logged by the user into the personal scheduler prior to the receipt of the incoming message from the third party;
the outgoing message has been composed by the user prior to the receipt of the incoming message from the third party;
when the message processor is a computer-based email system, then the incoming message is an incoming email message received at the computer-based email system and the outgoing message is an outgoing email message transmitted to the third party;
when the message processor is a voice mail system, then the incoming message is an incoming telephone call received at the voice mail system and the outgoing message is an outgoing voice message transmitted to the third party; and
information in the outgoing message is selected based on at least one of (1) a particular type of current activity for the user logged into the personal scheduler, wherein different information is associated with different types of user activities capable of being logged into the personal scheduler and (2) information regarding the third party.

24. A machine-readable medium, having encoded thereon program code, wherein, when the program code is executed by a machine, the machine implements a method for processing incoming messages from third parties, comprising the steps of:
(a) receiving an incoming message from a third party intended for a user; and
(b) supplying an outgoing message in response to the incoming message, wherein the outgoing message is selected as a function of information stored in a computer-based personal scheduler.

25. A computer-based system for processing incoming messages from third parties, comprising:
(a) a message processor; and
(b) a personal scheduler, wherein the personal scheduler is coupled to the message processor so that an incoming message is processed as a function of information stored in the personal scheduler.

26. The invention of claim 25, wherein an outgoing message is supplied in response to the incoming message, wherein the outgoing message is selected as a function of the information stored in the personal scheduler.
